(19) United States
(12) Patent Application Publication
(10) Pub. No.: US 2001/0042026 A1
(43) Pub. Date: Nov. 15, 2001

(54) Internet purchase system

(76) Inventors: Ken D. Hinh, League City, TX (US); Grant M. Howe, Houston, TX (US)

Correspondence Address: FULBRIGHT & JAWORSKI L.L.P., Suite 2800, 2200 Ross Avenue, Dallas, TX, 75201, US

(21) Appl. No.: 09/794,205

(22) Filed: Feb. 27, 2001

Related U.S. Application Data
(63) Continuation of application No. 09/442,138, filed on Nov. 17, 1999, now abandoned.
(60) Provisional application No. 60/108,789, filed on Nov. 17, 1998.

(51) Int. Cl. G06F 17/60

(52) U.S. Cl. 705/26

(57) ABSTRACT

A computer having connections to a digital communication medium accepts purchase inquires and purchase orders, executes the purchase inquires and orders by interfacing with provider computer databases, and transmits an electronic digital signal which can be printed as a verification of an executed purchase order. In one embodiment, a computer having connections to the Internet collects information from a customer operating a remote computer via a user interface provided by the computer. The user interface is further used to display purchase information retrieved by the computer from provider computer databases. Once the customer authorizes a purchase, the computer executes the order and transmits computer code readable by a web browser that contains encrypted information which provides printable verification of the purchase order.

### CROSS REFERENCE TO RELATED APPLICATIONS

This application claims priority to Provisional U.S. patent application Ser. No. 60/108,789, filed Nov. 17, 1998, which is hereby incorporated by reference for all purposes.

### BACKGROUND OF THE INVENTION

The present invention relates generally to methods for providing a customer with a printer-outputted, encodable printed verifiable proof of purchase for a product or service made over the Internet.

The growing prevalence of commerce over the Internet has provided customers with greater choices for products and services. Shopping over the Internet may also provide greater savings by allowing customers a very efficient way of comparison shopping. Moreover, making purchases over the Internet may often eliminate the need to make a physical trip to a store or retail outlet.

However, the potential for such useful and convenient utilization of the Internet has been hampered by the uncertainty that attaches to paying for services and having no proof of purchase. Thus, a need remains for a method to make a purchase of services or goods over the Internet and have a verifiable proof of purchase immediately printed on a printer at the purchaser's computer. There also remains a need for the seller to provide such a proof of purchase that is not susceptible to fraudulent use. There is a further need for a seller to have the ability to sell the entitlement for a good or service by providing the purchaser with a tangible medium that the purchaser can exchange for the purchased good or service.

The present invention overcomes these deficiencies.

### SUMMARY OF THE INVENTION

The internet purchase system of the present invention includes a remote computer of a customer having a printer attached thereto accessing a system server on the Internet using a web browser. The system server includes a customer database and has access to one or more of service provider servers, each of which includes a database for the products and services provided by that service provider. The customer queries the system server about the products and services offered by one or more of the service providers which in turn queries the databases of the service providers through the service provider servers. Upon analyzing and comparing the information provided by the system server on the various products and services provided by the service providers, the customer may order a product or service from a particular service provider using the order form on the system server. Upon verification of the customer's account, the customer's printer prints a receipt for the purchase. The receipt includes information which may later be verified by the service provider. One type of receipt includes the use of bar coded information which serves to entitle the purchaser to certain services upon presentation of the receipt and which may be readily verified by the service provider. This type of receipt may include tickets, money orders, shipping labels, or other documents as verifiable proof of payment for a product or service.

Thus, the present invention comprises a combination of features and advantages which enable it to overcome various problems of prior devices and methods. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 illustrates processor-based systems of the preferred embodiment of the present invention;

FIG. 2 illustrates a flow chart of a representative set of web pages for the system of FIG. 1;

FIG. 3 illustrates a flow chart of the steps performed by the system of FIG. 1;

FIG. 4 illustrates a series of codes for the ordering process of the system of FIG. 1; and

FIG. 5 illustrates an flow chart for an exemplary business method for the system of FIG. 1.

### DETAILED DESCRIPTION OF THE PREFERRED EMBODIMENT

Referring initially to FIG. 1, a preferred receipt generation system 2 includes a server 4 and access to the Internet 6. The customer utilizes remote computer 8 running web browser 10 to communicate via Internet 6 to server 4. Remote computer 8 has attached a printer 12.

For products or services requiring electronic printing of a receipt, server 4 processes orders, verifies authorization and account balances for such orders, and transmits an electronically generated receipt to the customer. Server 4 has access to a network 18 of databases 20 containing cost information provided by various product or service providers. Server 4 cooperates with product or service provider systems to electronically generate a receipt that has sufficient information to assure the customer that the electronic receipt will be honored by the issuing product or service provider. Likewise, the electronically generated information can include specific data, encoded or otherwise, that assures the product or service provider that the electronically generated receipt represents a valid purchase transaction. Bar codes are one well known example of encoded data capable of recording purchase transaction information. Other data recording methods utilizing graphics that can be printed on attached printer 8 can also be employed. It should be appreciated that although the apparatus and methods described are directed to accessing a plurality of product or service providers that the present invention may also be used directly between a customer and product or service provider.

Generally, server 4 utilizes web server 14 to provide a connection and administration layer to handle customer log-in, customer account management, and Secure Sockets Layer (SSL) security. Server 4 also utilizes business object server 16 to execute address verification, receipt generation, cost lookup, event logging and payment processing. Server 4 utilizes customer database 21 to manage customer accounts and billing transactions. Server 4 also has access to codes and subroutines that can calculate costs and can conduct verification of customer accounts and transactions. Such codes and subroutines are well known in the art and would be readily apparent to one of ordinary skill in the art.

Preferred system 2 includes software based on technologies such as HyperText Markup Language (HTML), Active Server Pages (ASP) technology, Java Applets, Remote Scripting, and JavaScript to enable a digital data exchange of the information required to accomplish the tasks and transactions required to generate electronic receipts.

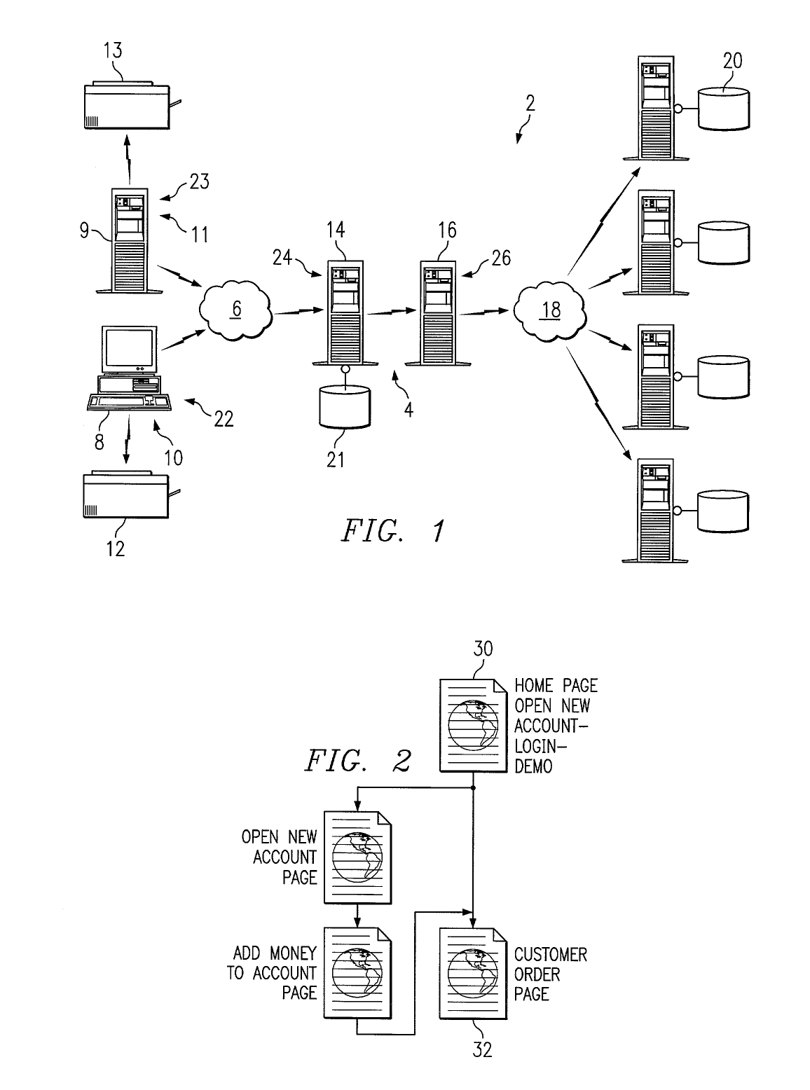

Referring now to FIG. 2, a flow chart is shown for a representative set of web pages on server 4. The customer on remote computer 8 shown in FIG. 1 uses web browser 10 of FIG. 1 to log onto home page 30 from which the customer may access order page 32 for ordering products or services. Order page 32 uses well known code such as Java Applets to allow the customer to enter product or service criteria information such as color, model number, catalogue number, and other product or service information. The subroutines and scripts for accepting such information will be readily apparent to one of ordinary skill in the art. The customer may initiate an “on line” order by submitting criteria information into order page 32. In the preferred embodiment, the order web page provides the user with a dynamic interactive interface during receipt generation.

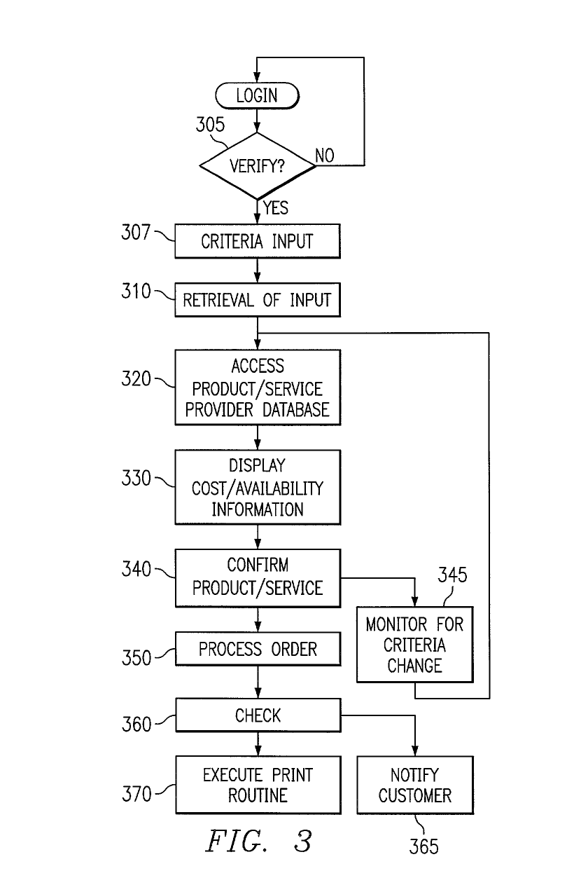

Referring now to FIG. 3, a flow chart is shown for the steps performed by preferred system 2. This flow chart illustrates how the preferred system 2 processes the criteria information and purchase order provided by the customer. Upon logging onto order page 32 shown in FIG. 2, the customer's identification and account information is verified at step 305. If the customer has entered incorrect information, the preferred system 2 prompts the customer for re-entry of such information. Upon successful log-in, the customer uses the preferred electronic receipt generation system by inputting criteria information at step 307. The codes and routines for verifying a log-in and for collecting information from web browser 10 are well known in the art. After the customer inputs criteria information, this information is retrieved by the server 4, shown in FIG. 1, at step 310. A comparison of products or services offered by a provider with the criteria information submitted by the customer is accomplished at step 320. At step 320, the cost and availability data of product or service corresponding with the criteria information is obtained.

Referring now to the Annex, Part A, exemplary offering routine 40 accesses product or service provider databases 20 shown in FIG. 1 to determine or compare the cost and availability of the product or service among providers corresponding to the criteria information. It should be understood that step 320 shown in FIG. 3 may simultaneously process and compare any number of inputted customer criteria. For example, one such customer criteria may be a comparison of cost or availability information from a number of competitors. Another example may be a comparison of cost or availability information for varying grades of quality of a particular product or service provider. Providing such additional capability will be readily apparent to one of ordinary skill in the art.

Referring again to FIG. 3, the information obtained at step 310 and at step 320 is displayed to the customer at step 330 with a “what you see is what you get” (WYSIWYG) user interface that changes in response to customer selections. The print “preview” changes dynamically and immediately in response to customer selections. The WYSIWYG provides a print “preview” of the electronic receipt generated in accordance with the customer's inputted information. Illustrative sample code to provide a WYSIWYG format is shown in the Annex, Part B. Preferred electronic receipt generation system 2 shown in FIG. 1 may utilize HTML, ASP, Remote Scripting, JavaScript, and Java Applets to provide a highly interactive order web page 32 as shown in FIG. 2.

Referring now to FIG. 3 and the Annex, Part C, the customer may verify and order the product or service displayed or choose to change the criteria information at step 340. At step 345, exemplary query routine shown in the Annex, Part C automatically retrieves cost and availability information as the customer changes criteria information. It should be understood that the Annex illustrates merely a sample code, modifications of which would be apparent to one of ordinary skill in the art.

If the customer chooses to complete the purchase, the customer's acceptance is processed at step 350. At step 360, the customer is notified if an error occurs with the ordering process. Otherwise, the preferred system 2 executes a series of codes at step 350 (shown in FIG. 3) that are shown in FIG. 4. First, a check is made of the customer's account information. Exemplary checking codes are shown in the Annex, Part D. Second, the customer criteria information is used to purchase the service or product and the purchaser price is deducted from the customer's account in payment of the product or service. Exemplary purchasing codes are shown in the Annex, Part E. Third, the proof of confirmation sent by the product or service provider is accepted by the preferred system 2. Exemplary proofing code is shown in the Annex, Part F. A containment object may also be added to coordinate the transactions with product or service provider databases. An exemplary containment object is provided in the Annex, Part G. At any point the customer order fails, the customer is notified at step 370 shown in FIG. 3.

Referring again to FIG. 3, upon successful execution of the customer order, the purchase and printing of the electronically generated receipt is accomplished at step 370. At step 370, the electronic receipt generated by the preferred receipt generation system is printed on the attached printer 12 shown in FIG. 1 of customer's remote computer 8. Printing can be accomplished by the exemplary receipt printing routine 120 shown in the Annex, Part H. Thus, the steps shown in FIG. 3 provide the customer with an electronically generated receipt that includes a bar code or other forms of data that can be used to validate or authenticate the electronically generated receipt when redeemed by the customer. From the perspective of the product or service provider, the steps shown in FIG. 3 conclude with cost-effective sale of services or goods that is represented by an electronically generated receipt encoded with sufficient data to permit the detection of fraud or theft. Current encoding methods include bar codes, however nearly any method of graphical encoding or encryption may be used in the printing of the electronically generated receipt. Thus the electronically generated receipt can be scanned by a third party or a product or service provider for verification of authenticity. Exemplary verification code for determining the authenticity of an electronically generated receipt shown in the Annex, Part I.

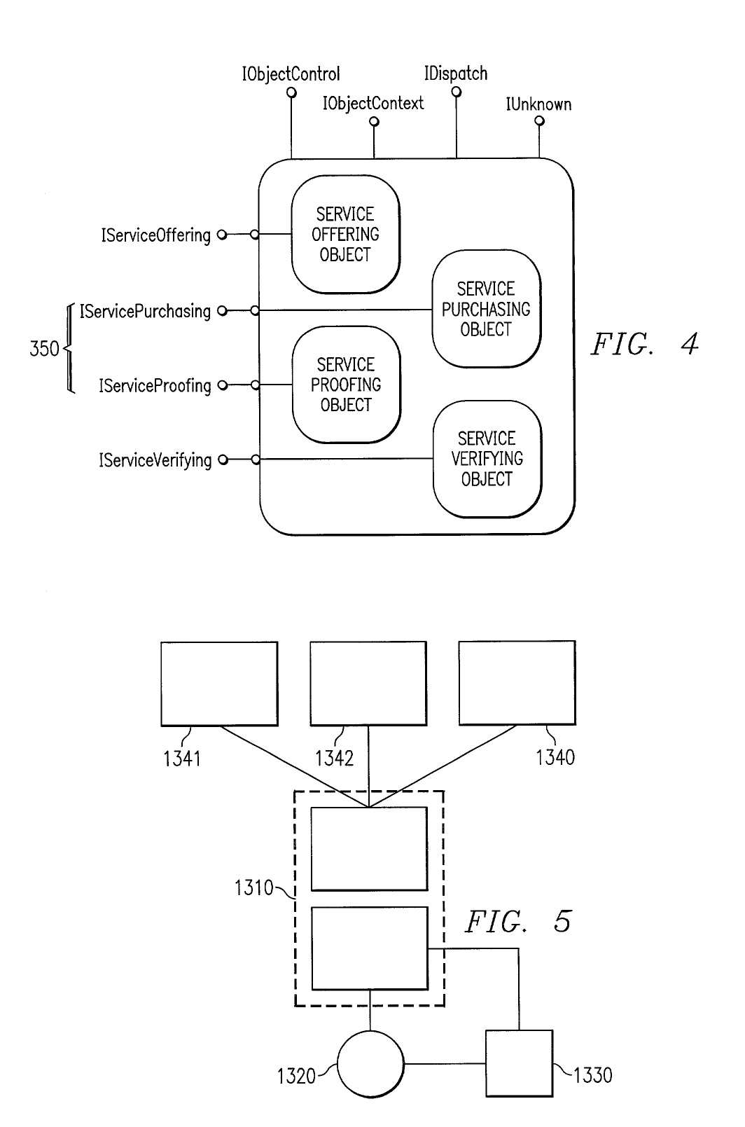

Preferred electronic receipt generation system is readily adapted to a method of doing business as an intermediary. Referring now to FIG. 5, the server 4 of FIG. 3 is utilized by the intermediary 1310. Customer 1320 opens an account with intermediary 1310 using a credit account issued by financial institution 1330 such as credit card company. Thus, orders made by customer 1320 are charged against the customer's account at financial institution 1330. Intermediary 1310 negotiates with product or service providers 1340, 1341, 1342 for an electronic interactive business relationship as described in steps 320, 340 and 350 of FIG. 3. Thus, intermediary 1310 uses the server 4 of FIG. 1 to compare product or service offerings of providers 1340, 1341, 1342 as stored on product or service provider databases 20 of FIG. 1, and to purchase such products or services offered. Intermediary 1310 is invoiced by providers 1340, 1341, 1342 for the purchases of products or services offered.

Typically, customer 1320 logs onto the web ordering page 32 shown in FIG. 2 of Intermediary 1310 using the remote computer 8 of FIG. 1. Customer 1320 locates a particular product or service matching certain criteria information. Customer 1320 then authorizes intermediary 1310 to order the product or service. Intermediary 1310 orders the product or service and requests authorization for an electronic receipt for customer 1320. However, intermediary 1310 directs product or service provider 1340, 1341, 1342 to bill intermediary 1310. Intermediary 1310 accepts the electronic receipt issued by product or service provider 1340, 1341, 1342 and makes an appropriate charge against the charge account at financial institution 1330 of customer 1320. After intermediary 1310 verifies the billing and authorization information, the electronic receipt is sent to customer 1320 for printing on the attached printer 12 of FIG. 1.

The preferred system is easily adapted to numerous embodiments. For example, instead of a web browser, a “stand alone” application could be used by the customer or to the preferred system. Indeed, the “stand alone” application may be easily crafted to the needs of a business that may transact a high volume of business over a preferred system. Further, encryption hardware or software could be easily implemented into the preferred system. If the product or service provider utilizes encryption techniques, compatible hardware and software can be installed on server 4 to handle encrypted information. Moreover, electronic receipts and order information not encrypted by service or product providers may be processed by encryption hardware installed directly on server 4.

Furthermore, it is to be understood that the term “receipt” used above should be interpreted in its broadest sense and include such purchases as airline tickets, lottery tickets, theatre tickets, money orders, shipping labels or any other documents that provide verification of the rightful possession of a product or rightful entitlement to use a service. It will be understood that the products and services listed above are representative of commodities that have intrinsic value. A prior art receipt, as understood in certain circumstances, merely evidences a transaction for the purchase of a good or service and, as such, has no intrinsic value. However, a receipt, as contemplated in the present invention, can be, in certain circumstances, synonymous with the goods or rights to the service. That is, the receipt is itself a commodity. Furthermore, it will be understood that while a receipt may typically be embodied or fixed in a paper medium, a receipt may just as easily be fixed in a computer readable magnetic medium such as a computer diskette or tape, a laser-optical medium such as a CD-ROM or DVD, or other similar computer readable medium.

Preferred electronic receipt generation system, in its simplest form, enables a provider of a commodity to transmit a digital code that can be converted by a remote computer into the commodity. Including verification or encryption code into the digital code enhances the ability of the provider or a third party to authenticate the commodity.

Additionally, the preferred system can be configured in numerous ways without departing from the essence of the present invention. For example, server 4 may be either one server or a series of servers. Indeed, the scalability of server 4 provides preferred system with additional flexibility in handling multiple connections to product or access providers. Additionally, the connection to the product or service providers may vary according to the agreements between such providers. It is conceivable that one product or service provider may allow direct Internet access to its databases while another product or service provider require a formal logging-in procedure. Thus, the software enabling the data exchange and order confirmations between the various product or service providers will typically vary in their nature and complexity. It is noted however that software for execution of such tasks are generally well known in the art and would be apparent one of ordinary skill in the art. Of course, if a product or service provider allows its databases to be linked directly with server 2, the need for access to product or service providers via the Internet or some other means is obviously eliminated.

While preferred embodiments of the invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

### Annex

### Part A

### Service Provider Business Objects

// ServiceOffering.h : Declaration of the CServiceOffering
#ifndef_SERVICEOFFERING_H_{—}
#define_SERVICEOFFERING_H_{—}

| | |
|---|---|
| #include “resource.h” | // main symbols |

#include <mtx.h>
//////////////////////////////////////////////////////////////////////////////////////////////////////////
// CServiceOffering
class ATL_NO_VTABLE CServiceOffering :

public CComObjectRootEx<CComSingleThreadModel>,
public CComCoClass<CServiceOffering, &CLSID_Service

Offering>,

public IObjectControl,
public IDispatchImpl<IServiceOffering, &IID_IServiceOffering,

&LIBLD_SERVICEPROVIDERLib>
{
public:

CServiceOffering( )
{
}

DECLARE_REGISTRY_RESOURCEID(IDR_SERVICEOFFERING)
DECLARE_PROTECT_FINAL_CONSTRUCT( )
DECLARE_NOT_AGGREGATABLE(CServiceOffering)
BEGIN_COM_MAP(CServiceOffering)

COM_INTERFACE_ENTRY(IServiceOffering)
COM_INTERFACE_ENTRY(IObjectControl)
COM_INTERFACE_ENTRY(IDispatch)

END_COM_MAP( )
// IObjectControl
public:

STDMETHOD(Activate)( );
STDMETHOD_(BOOL, CanBePooled)( );
STDMETHOD_(void, Deactivate)( );
CComPtr<IObjectContext>m_spObjectContext;

// IServiceOffering
public:

STDMETHOD(GetServices)(ADORecordset*

ServiceRecordsetPtr);

};
#endif //_SERVICEOFFERING_H_{—}
// ServiceOffering.cpp : Implementation of CServiceOffering
#include “stdafx.h”
#include “ServiceProvider.h”
#include “ServiceOffering.h”
//////////////////////////////////////////////////////////////////////////////////////////////////////////
// CServiceOffering
HRESULT CServiceOffering::Activate( )
{

HRESULT hr = GetObjectContext(&m_spObjectContext);
if (SUCCEEDED(hr))

return S_OK;

return hr;

}
BOOL CServiceOffering::CanBePooled( )
{

return TRUE;

}
void CServiceOffering::Deactivate( )
{

m_spObjectContext.Release( );

}
STDMETHODIMP CServiceOffering::GetServices(ADORecordset

*ServiceRecordsetPtr)

{

//Open internet connection to service provider
//Could use DCOM, RPC, CORBA, SNA, etc depends on provider's
//systems
//Query service provider's database for services, ID's, cost per unit,
//availability, variations, etc.
//Close connection with provider
//Place query results in an ADO recordset for use in the ASP page
//Add a reference to the recordset and return

return S_OK;

}
PART B
Customer Interface Java Applets
WYSIWYG preview style UI:
public void paint(Graphics a_g)
{

setDeviceContext(a_g);
m_ServiceForm.calculateFormDisplay(m_nServiceForm);
m_ServiceForm.drawFrame( );
m_DrawForm.draw( );

}
PART C
Sample Code Attachments
Cost Lookup:
1. User's Browser (on HTML page)
function changeType(what)
{

nType = what.form.chType.selectedIndex
ServiceSup.setType(nType);
queryRangePrice(nType);

}
function queryRangePrice (nType)
{

var context = “Cost Range”
var rsService = RSGetASPObject(“Service_RS.asp”)
co = rsService.QueryRangePrice(nType, queryRangePriceCallBack,

errorCallBack, context)

}
function queryRangePriceCallBack (co)
{

var sCosts, sNewCosts, sDelimiter1, sDelimiter2, sPrefix1, sPrefix2,

sPrefix3

if(co.status != −1)
{

sCosts = co.return_value
if (sPrices == “ERROR”)

alert(sPrices)

else
{

// Reformat mail class string array.
sDelimiter1 = “Amount = ”
sDelimiter2 = “MaxWeight = ”
sPrefix1= “ − ”
sPrefix2= “ oz. at $”
sNewCosts = ServiceSup.parseString2(sCosts, sDelimiter1,

sDelimiter2, sPrefix1, sPrefix2)

ServiceSup.setCosts(sNewCosts)

}

}
else

alert(“Could not communicate with Service Server.”)

}
2. Web Server (on ASP):
function calculateCost(a_sVendor, a_sType, a_sWeight, a_sDestZip,
a_SenderZip)
{

var CostLookup = new ActiveXObject(“Service.CostLookup”);
return CostLookup.calculateCost(a_sVendor, a_sType, a_sWeight,

a_sDestZip, a_sSenderZip);
}
PART D
Address Correction:
1. User's Browser (on HTML page)
function correctAddress( )
{

var sOldDelimiter, sNewDelimiter, sAddress, data
var rsService = RSGetASPObject(“Service_RS.asp”)
sAddress = ServiceSup.prepareAddress(Service.getDestAddress( ))
data = rsSERVICE.CorrectAddress(sAddress)
if(data.status != −1)
{

m_sVerAddress = data.return_value
if (m_sVerAddress.indexOf(“ERROR”) != −1)
{

alert(m_sVerAddress)
m_sVerAddress = “”
exit

}
else if (m_sVerAddress.indexOf(“˜”) != −1)
{

m_sVerAddress = ServiceSup.multipleAddressDlg

(m_sVerAddress)

if (m_sVerAddress.length != 0)
{

Service.setDestAddress(m_sVerAddress, false);
ServiceSup.setDestAddress(Service.getDestAddress( ))

}

}
ServiceSup.setDestAddress(m_sVerAddress)
Service.setDestAddress(m_sVerAddress, false)

}

}
2. Web Server (on ASP):

function correctAddress(a_sAddress)
{

var CorrectAddress = new ActiveXObject

(“Service.CorrectAddress.1”);

return CorrectAddress.verify(a_sAddress);

}

PART E
Service Provider Business Objects
// ServicePurchasing.h : Declaration of the CServicePurchasing
#ifndef_SERVICEPURCHASING_H_{—}
#define_SERVICEPURCHASING_H_{—}

| | |
|---|---|
| #include “resource.h” | // main symbols |

#include <mtx.h>
//////////////////////////////////////////////////////////////////////////////////////////////////////////
// CServicePurchasing
class ATL_NO_VTABLE CServicePurchasing:

public CComObjectRootEx<CComSingleThreadModel>,
public CComCoClass<CServicePurchasing, &CLSID_Service

Purchasing>,

public IObjectControl,
public IDispatchImpl<IServicePurchasing, &IID_IService

Purchasing,

&LIBID_SERVICEPROVIDERLib>
{
public:

CServicePurchasing( )
{
}

DECLARE_REGISTRY_RESOURCEID(IDR_SERVICE

PURCHASING)

DECLARE_PROTECT_FINAL_CONSTRUCT( )
DECLARE_NOT_AGGREGATABLE(CServicePurchasing)
BEGIN_COM_MAP(CServicePurchasing)

COM_INTERFACE_ENTRY(IServicePurchasing)
COM_INTERFACE_ENTRY(IObjectControl)
COM_INTERFACE_ENTRY(IDispatch)

END_COM_MAP( )
// IObjectControl
public:

STDMETHOD(Activate)( );
STDMETHOD_(BOOL, CanBePooled)( );
STDMETHOD_(void, Deactivate)( );
CComPtr<IObjectContext>m_spObjectContext;

// IServicePurchasing
public:

STDMETHOD(PurchaseService)(long lIDofService, long

lQuantity, long lCustomerNum, long* lOrderConfirmationNum);
};
#endif //_SERVICEPURCHASING_H_{—}
// ServicePurchasing.cpp : Implementation of CServicePurchasing
#include “stdafx.h”
#include “ServiceProvider.h”
#include “ServicePurchasing.h”
////////////////////////////////////////////////////////////////////////////////////////////////////////////
// CServicePurchasing
HRESULT CServicePurchasing::Activate( )
{

HRESULT hr = GetObjectContext(&m_spObjectContext);
if (SUCCEEDED(hr))

return S_OK;

return hr;

}
BOOL CServicePurchasing::CanBePooled( )
{

return TRUE;

}
void CServicePurchasing::Deactivate( )
{

m_spObjectContext.Release( );

}
STDMETHODIMP CServicePurchasing::PurchaseService(long
lIDofService, long lQuantity, long lCustomerNum, long *lOrder
ConfirmationNum)
{

//Open internet connection to service provider

//Could use DCOM, RPC, CORBA, SNA, etc depends on provider's
//systems
//Query service provider's database for this service cost per unit,
//availability, variations, etc.
//Check available quantity
//Calculate total charge
//look up customer account information
//Verify customer credit card for charge of that amount
//Enter order into providers system to be billed to this brokerage service
//but delivered to customer
//Close connection with provider
//Charge customer's credit card for amount plus brokerage fee
//Provider does not bill until later, but we enjoy the float now
//Create order record in database
//Issue order confirmation number and return

return S_OK;

}
PART F
Service Provider Business Objects
// ServiceProofing.h : Declaration of the CServiceProofing
#ifndef_SERVICEPROOFING_H_{—}
#define_SERVICEPROOFING_H_{—}

| | |
|---|---|
| #include “resource.h” | // main symbols |

#include <mtx.h>
///////////////////////////////////////////////////////////////////////////////////////////////////////////
// CServiceProofing
class ATL_NO_VTABLE CServiceProofing :

public CComObjectRootEx<CComSingleThreadModel>,
public CComCoClass<CServiceProofing, &CLSID_Service

Proofing>,

public IObjectControl,
public IDispatchImpl<IServiceProofing, &IID_IService

Proofing,

&LIBID_SERVICEPROVIDERLib>
{
public:

CServiceProofing( )
{
}

DECLARE_REGISTRY_RESOURCEID(IDR_SERVICEPROOFING)
DECLARE_PROTECT_FINAL_CONSTRUCT( )
DECLARE_NOT_AGGREGATABLE(CServiceProofing)
BEGIN_COM_MAP(CServiceProofing)

COM_INTERFACE_ENTRY(IServiceProofing)
COM_INTERFACE_ENTRY(IObjectControl)
COM_INTERFACE_ENTRY(IDispatch)

END_COM_MAP( )
// IObjectControl
public:

STDMETHOD(Activate)( );
STDMETHOD_(BOOL, CanBePooled)( );
STDMETHOD_(void, Deactivate)( );
CComPtr<IObjectContext> m_spObjectContext;

// IServiceProofing
public:

STDMETHOD(GenerateDigitalReceipt)(long lCustomerNum,

long lOrderConfirmationNum, VARIANT* vDigitalReceiptCodes);
};
#endif//_SERVICEPROOFING_H_{—}
// ServiceProofing.cpp : Implementation of CServiceProofing
#include “stdafx.h”
#include “ServiceProvider.h”
#include “ServiceProofing.h”
///////////////////////////////////////////////////////////////////////////////////////////////////////////
// CServiceProofing
HRESULT CServiceProofing::Activate( )
{

HRESULT hr = GetObjectContext(&m_spObjectContext);
if (SUCCEEDED(hr))

return S_OK;

return hr;

}
BOOL CServiceProofing::CanBePooled( )
{

return TRUE;

}
void CServiceProofing::Deactivate( )
{

m_spObjectContext.Release( );

}
STDMETHODIMP CServiceProofing::GenerateDigitalReceipt(long
lCustomerNum, long lOrderConfirmationNum, VARIANT*
vDigitalReceiptCodes)
{

//Lookup customer number in database
//Lookup order confirmation in database
//Confirm data match between customer number and confirmation

number

//Encrypt customer data, order data, and unique confirmation number

using provider's assigned private key

//Package data into variant
//Add reference to variant and return

return S_OK;

}
PART G
Service Provider Business Objects
// ServiceProvider.idl : IDL source for ServiceProvider.dll
//
// This file will be processed by the MIDL tool to
// produce the type library (ServiceProvider.tlb) and marshalling code.
import “oaidl.idl”;
import “ocidl.idl”;
import “adorecordset.idl”;

[

object,
uuid(CD89C59F-7C44-11D2-B49F-000000000000),
dual,
helpstring(“IServiceOffering Interface”),
pointer_default(unique)

]
interface IServiceOffering : IDispatch
{

[id(1), helpstring(“method GetServices”)] HRESULT

GetServices(ADORecordset* ServiceRecordsetPtr);

};
[

object,
uuid(CD89C5A1-7C44-11D2-B49F-000000000000),
dual,
helpstring(“IServicePurchasing Interface”),
pointer_default(unique)

]
interface IServicePurchasing : IDispatch
{

[id(1), helpstring(“method PurchaseService”)] HRESULT

PurchaseService(long lIDofService, long lQuantity, long ICustomerNum,
long* lOrderConfirmationNum);

};
[

object,
uuid(CD89C5A6-7C44-11D2-B49F-000000000000),
dual,
helpstring(“IServiceProofing Interface”),
pointer_default(unique)

]
interface IServiceProofing : IDispatch
{

[id(1), helpstring(“method GenerateDigitalReceipt”)]

HRESULT GenerateDigitalReceipt(long lCustomerNum, long
lOrder Confirmation Num, VARIANT* vDigitalReceiptCodes);

};
[

object,
uuid(CD89C5AA-7C44-11D2-B49F-000000000000),
dual,
helpstring(“IServiceVerifying Interface”),
pointer_default(unique)

]
interface IServiceVerifying : IDispatch
{

[id(1), helpstring(“method VerifyReceipt”)] HRESULT

VerifyReceipt(VARIANT vDigitalReceipt, long lVendorNumber, BOOL*
bAuthentic);

[id(2), helpstring(“method ClaimServices“)] HRESULT

ClaimServices(VARIANT vDigitalReceipt, long lVendorNumber, long*
lAuthorizationNumber);

};

[

uuid(CD89C591-7C44-11D2-B49F-000000000000),
version(1.0),
helpstring(“ServiceProvider 1.0 Type Library”)

]
library SERVICEPROVIDERLib
{

importlib(“stdole32.tlb“);
importlib(“stdole2.tlb”);
[

uuid(CD89C5A0-7C44-11D2-B49F-000000000000),
helpstring(“ServiceOffering Class”)

]
coclass ServiceOffering
{

[default] interface IServiceOffering;

};
[

uuid(CD89C5A2-7C44-11D2-B49F-000000000000),
helpstring(“ServicePurchasing Class”)

]
coclass ServicePurchasing
{

[default] interface IServicePurchasing;

};
[

uuid(CD89C5A7-7C44-11D2-B49F-000000000000),
helpstring(“ServiceProofing Class”)

]
coclass ServiceProofing
{

[default] interface IServiceProofing;

};
[

uuid(CD89C5AB-7C44-11D2-B49F-000000000000),
helpstring(“ServiceVerifying Class”)

]
coclass ServiceVerifying
{

[default] interface IServiceVerifying;

};

};
PART H
Printing Java Applets
Printing Receipt:
public boolean printReceipt(String a_sData, boolean a_bReal)
{

if(!a_bReal)
{

a_sData = “”;
if (!m_printEng.printerSelection(m_nForm))

return false;

}
m_printEng.print(a_sData, m_nForm);
if (a_bReal)
{

m_DrawReceipt.setRealOrder(false);

Point ptStartPoint = m_MailForm.getStartPoint ( );
repaint(ptStartPoint.x, ptStartPoint.y, ptStartPoint.x+200,

ptStartPoint.y+110);

}
return true;

}
public void printReceiptProcess( )
{

m_jprint.StartDoc(“”);
m_jprint.StartPage( );
calculatePrintForm(m_jprint);
int nFormType = m_Serice.getFormType( );
DrawAddress objSenderAddress = (DrawAddress)(m_Service.

getSenderAddressObj( ));

obj SenderAddress.draw(m_ptSenderAddress, false);

DrawAddress objDestAddress = (DrawAddress)(m_Service.

getDestAddressObj( ));

objDestAddress.setDeviceContext(m_jprint);
objDestAddress.draw(m_ptDestAddress, true);
DrawForm objDrawForm = (DrawForm)(m_Service.

getDrawFormObj( ));

objDrawForm.setDeviceContext(m_jprint);
objDrawForm.setRealForm(m_bRealForm);
objDrawForm.draw(m_ptStartPoint);
m_jprint.EndPage( );
m_jprint.EndDoc( );
m_jprint.ReleasePrinter( );

}
Order and Print Receipt:
1. User's Browser (on HTML page)
function printReceipt( )
{

var rsService, sAmount, sDate , sData, sType
rsService = RSGetASPObject(“Service_RS.asp”);
co = rsService.order(sAmount, sDate, sDestAddress, sType,

printReceiptCallBack, errorCallBack, context);
}
function printReceiptCallBack (co)
{

if (co.status != −1)
{

var sData = co.return_value
if (sData.indexOf(“ERROR”) != −1)

alert(sData)

else
{

nFound = sData.indexOf(“;”);
g_sBalance = sData.substr(0, nFound);
sData = sData.substr(nFound+1);
ServiceSup.setBalance(g_sBalance)
Service.printReceipt(g_sCustomerID, true);

}

}

}
function calculateCost(a_sVendorID, a_sType, a_sWeight,

a_sDestZip, a_sSenderZip)

{

var Cost = new ActiveXObject(“Service.Cost”);
return Cost.calculateCost(a_sVendorID, a_sType, a_sWeight,

a_sDestZip, a_sSenderZip);

}
2. Web Server (on ASP):
function order(sAmount, sDate, sDestAddress, sType)
{

var sBalance, sData, sResult, Order;
Order = new ActiveXObject(“Service.Order.1”);
sData = Order.Debit(sAmount, sDate, sDestAddress, sType);
sBalance = getShopperBalance( );
sResult = sBalance + “;” + sData;
return sResult;

}
PART I
Service Provider Business Objects
// ServiceVerifying.h : Declaration of the CServiceVerifying
#ifndef_SERVICEVERIFYING_H_{—}
#define_SERVICEVERIFYING_H_{—}

| | |
|---|---|
| #include “resource.h” | // main symbols |

#include <mtx.h>
///////////////////////////////////////////////////////////////////////////////////////////////////////////
// CServiceVerifying
class ATL_NO_VTABLE CServiceVerifying :

public CComObjectRootEx<CComSingleThreadModel>,
public CComCoClass<CServiceVerifying, &CLSID_Service

Verifying>,

public IObjectControl,
public IDispatchImpl<IServiceVerifying, &IID_IService

Verifying,

&LIBID_SERVICEPROVIDERLib>
{
public:

CServiceVerifying( )
{
}

DECLARE_REGISTRY_RESOURCEID(IDR_SERVICEVERIFYING)
DECLARE_PROTECT_FINAL_CONSTRUCT( )
DECLARE_NOT_AGGREGATABLE(CServiceVerifying)
BEGIN_COM_MAP(CServiceVerifying)

COM_INTERFACE_ENTRY(IServiceVerifying)
COM_INTERFACE_ENTRY(IObjectControl)
COM_INTERFACE_ENTRY(IDispatch)

END_COM_MAP( )
// IObjectControl
public:

STDMETHOD(Activate)( );
STDMETHOD_(BOOL, CanBePooled)( );
STDMETHOD_(void, Deactivate)( );
CComPtr<IObjectContext> m_spObjectContext;

// IServiceVerifying
public:

STDMETHOD(ClaimServices)(VARIANT vDigitalReceipt,

long lVendorNumber, long* lAuthorizationNumber);

STDMETHOD(VerifyReceipt)(VARIANT vDigitalReceipt,

long lVendorNumber, BOOL* bAuthentic);
};
#endif//_SERVICEVERIFYING_H_{—}
// ServiceVerifying.cpp : Implementation of CServiceVerifying
#include “stdafx.h”
#include “ServiceProvider.h”
#include “ServiceVerifying.h”
///////////////////////////////////////////////////////////////////////////////////////////////////////////
// CServiceVerifying
HRESULT CServiceVerifying::Activate( )
{

HRESULT hr = GetObjectContext(&m_spObjectContext);
if (SUCCEEDED(hr))

return S_OK;

return hr;

}
BOOL CServiceVerifying::CanBePooled( )
{

return TRUE;

}
void CServiceVerifying::Deactivate( )
{

m_spObjectContext.Release( );

}
STDMETHODIMP CServiceVerifying::VerifyReceipt(VARIANT
vDigitalReceipt, long lVendorNumber, BOOL *bAuthentic)
{

//Unpackup Digital receipt

//Lookup vendor number in database
//Decrypt digital receipt with vendor's assigned public key and verify
//authenticity
//Lookup confirmation number record in database
//Verify digital receipt data against database
//Log Record access in the database for future reference
//Return flag indicating success or failure

return S_OK;

}
STDMETHODIMP CServiceVerifying::ClaimServices(VARIANT
vDigitalReceipt, long lVendorNumber, long *lAuthorizationNumber)
{

//Unpackup Digital receipt

//Lookup vendor number in database
//Decrypt digital receipt with vendor's assigned public key and verify
//authenticity
//Lookup confirmation number record in database
//Verify digital receipt data against database
//Log Record access in the database for future reference
//Mark order confirmation record as being fulfilled

C

//assign an authorization number to the confirmation database

return S_OK;

}

What is claimed is:

1. A method for delivering a digitally-produced commodity, comprising:
receiving a purchase order from a purchaser for the purchase of goods or services via a digital communication medium;
executing the purchase order; and
transmitting to the purchaser via the digital communication medium a digital signal that is converted by a remote computer into a tangible medium entitling the purchaser to the purchased goods, products or services.

2. The method of claim 1 wherein the tangible medium is selected from a group consisting of paper, a magnetic computer-readable medium and a laser/optical computer-readable medium.

3. The method of claim 1 wherein the commodity is selected from a group consisting of entitlement to a service, entitlement to admission for an event, and entitlement to a good.

4. The method of claim 1 wherein the digital signal includes encrypted information that can be used to verify the authenticity of the digitally-produced commodity.

5. The method of claim 1 further comprising:
receiving a first purchase query having a first criteria via the digital communication medium;
accessing via the digital communication medium at least one database of a first provider capable of satisfying the first purchase query;
retrieving first provider information responsive to the first purchase query first criteria; and
transmitting via the digital communication medium at least a portion of the first provider information.

6. The method of claim 5 further comprising accessing via the digital communication medium a database of a second provider capable of satisfying the first purchase query; retrieving second provider information responsive to the first purchase query first criteria; and transmitting via the digital communication medium at least a portion of the second provider information.

7. The method of claim 1 further comprising transmitting via the digital communication medium computer-readable code that provides a user interface for converting the digital signal into a commodity fixed in a tangible medium.

8. The method of claim 1 wherein the digital communication medium is the Internet.

9. A system for delivering a digitally produced commodity, comprising:
a computer;
a receiving module associated with said computer, said receiving module configured to receive the digital purchase order transmitted from a remote computer;
an executing module associated with said computer, said executing module configured to execute the digital purchase order; and
a transmitting module associated with said computer, said transmitting module configured to transmit a computer readable signal that can be converted by a remote computer into a commodity fixed in a tangible medium.

10. The system of claim 9, further comprising an encryption module, said encryption module configured to embed encrypted information into the computer-readable signal.

11. The system of claim 10 wherein said receiving module is further configured to receive a digital purchase inquiry; said accessing module is further configured to interface with at least one database to retrieve provider information responsive to the digital purchase query; and transmitting module is further configure to transmit at least a portion of the provider information.

12. The system of claim 11 wherein said interface module is further configured to transmit computer-readable code that provides a user interface on a remote computer screen for converting the digital signal into a commodity fixed in a tangible medium.

13. The system of claim 12 wherein said computer further comprises ports having connections to the Internet.

14. A method of conducting intermediary business transactions between a customer and a plurality of providers, comprising:
opening an account for the customer;
accepting a purchase query from the customer via an Internet connection;
interfacing via an Internet connection with a database of at least one provider capable of satisfying the purchase query to find at least one prospective provider;
retrieving information from the prospective provider;
transmitting to the customer via the Internet connection the prospective provider information;
accepting a purchase order from the customer via an Internet connection;
executing the purchase order;
charging the customer account; and
transmitting a digital signal that can be converted by a remote computer into a commodity fixed in a tangible medium.

15. A system for facilitating an Internet business transaction between a remote computer operated by a customer and a computer of at least one provider, comprising:
a computer;
a first Internet connection adapted to communicate with a remote computer operated by the customer;
a second Internet connection adapted to communicate with the provider computer;
a customer database associated with said computer, said customer database adapted to store customer account information;
a provider database associated with said computer, said provider database adapted to store provider account information;
a transaction module associated with said computer, said transaction module configured to execute a task selected from the group consisting of accepting a purchase query, accepting a purchase order, accessing a database of at least one provider to find information responsive to the purchase query, and executing a purchase order with at least one provider.
an interface module associated with said computer, said interface module configured to transmit a computer-readable code that provides a graphical user interface on the remote customer computer, said graphical user interface providing for customer input of a purchase query and a purchase order;
a verification module associated with said computer, said verification module configured to transmit encrypted data embedded in a digital code, said digital code a digital signal convertible by the customer computer into a commodity fixed in a tangible medium;
a customer interface module associated with said computer, said customer interface module configured to update said customer database upon substantial completion of the Internet business transaction; and
a provider interface module associated with said computer, said customer interface module configured to update said customer database upon substantial completion of the Internet business transaction.
